(19) United States
(12) Patent Application Publication
(10) Pub. No.: US 2010/0033045 A1
(43) Pub. Date: Feb. 11, 2010

(54) VIBRATING MOTOR

(75) Inventor: LE-PING DONG, SHENZHEN (CN)

Correspondence Address: Jamie Zheng, 3524 Waverley Street, Palo Alto, CA, 94306, US

(73) Assignees: AAC ACOUSTIC TECHNOLOGIES (SHENZHEN) CO., LTD, Shenzhen (CN); AMERICAN AUDIO COMPONENTS INC., La Verne, CA (US)

(21) Appl. No.: 12/536,493

(22) Filed: Aug. 6, 2009

(30) Foreign Application Priority Data
Aug. 8, 2008 (CN) 200820146536.4

(51) Int. Cl. H02K 7/065; H01R 39/18

(52) U.S. Cl. 310/81; 310/248

(57) ABSTRACT

A vibrating motor includes a base having a bearing mounting section, a magnet mounted on the base, a shaft assembled with the bearing mounting section, a pair of brushes located on the base and a rotor rotably supported by the shaft. Each of the brushes has a first contacting portion and a second contacting portion. The rotor includes a commutator facing the brushes. The commutator defines a plurality of segments. A gap is defined between two adjacent segments and extends along radial direction of the commutator. A connecting line connecting the first and second contacting portions is not through the shaft.

### CROSS-REFERENCE TO RELATED APPLICATIONS

This application claims priority to and the benefit of Chinese Patent Application No. 200820146536.4 filed in the State Intellectual Property Office of P.R.C. (SIPO) on Aug. 8, 2008, the entire contents of which are incorporated herein by reference.

### BACKGROUND OF THE INVENTION

1. Field of the Invention

The present invention generally relates to the art of motors, more particularly to a flat vibrating motor.

2. Description of Related Art

Flat vibrating motors are widely used in portable electronic products, such as mobile phones, for providing tactile vibration.

FIG. 1 illustrates a flat vibrating motor related to the present invention. The motor 50 comprises a base 51, a circuit board 52 positioned on the base 51, a electrical portion 53 electrically connected to the circuit board 52, a magnet 54 arranged above the base 51, a pair of brushes 55 fixed on the base, a shaft 56 supported by the case, a rotor 57 rotably supported by the shaft, and an upper case 58 forming a receiving cavity corporately with the base 51.

The base 51 provides a bearing mounting section 510 assembled with the shaft 56 for rotably supporting the shaft 56, and a mounting portion 511 for carrying the electrical portion 53.

The circuit board 52 includes a pair of first electrical terminals 520 on one end thereof and a pair of second electrical terminals 521 on another end thereof.

The electrical portion 53 provides a pair of buckles 530 coupled to the mounting portion 5 11 of the base 51 for assembling the electrical portion 53 with the base 51, and provides a pair of electrical contacts 531 electrically connected to the first electrical terminal 520.

The brushes 55 couple to the second electrical terminals 521 by soldering.

The rotor 57 includes a body 570, a plurality of coils 571 embedded in the body 570, and a weight 572 also embedded in the body 570. The body 570 provides a hole 573 for engaging the rotor 57 with the shaft 56. Thus, the rotor 57 is rotably assembled with the shaft 56.

Referring to FIG. 2, a commutator 574 attaches to a bottom of the body of the rotor 57. The commutator 574 comprises a plurality of segments for electrically connecting to the coils 571 and the brushes 55. Another word, the coils 571 are connected to the brushes 55 via the commutator 574.

When the first electrical terminals 520 receive current signals from an outer circuit via the electrical contacts 53 1, the current signals reach the coils 171 via the brushes 55. Activated by the electromagnetic force, the rotor 57 rotates about the shaft 56.

As shown in FIG. 3, a gap 575 is defined between two adjacent segments 574a, 574b. The gap 575 extends along the radial direction of the commutator 574. Each of the brushes 55 includes a first contacting portion 551 and a second contacting portion 552. The first and second contacting portions 551, 552 are electrically connected to the segments. A connecting line L′ connecting the first contacting portion 551 and the second contacting portion 552 is through a rotating center of the rotor 57, i.e., the connecting line L′ is through the shaft 56. Thus, while the rotor 57 rotates, at the same time, both of the two contacting portions 551, 552 could meet the gap 575, i.e., the two contacting portions 551, 552 could not contact with the segment, as shown in FIG. 4. At this moment, the bushes are not electrically connected to the segments. So the motor could not work.

In order to solve this problem, another motor related to the present invention is disclosed. Referring to FIG. 5, the gap 675 between two adjacent segments (674a and 675b) is not through a rotating center of the rotor 57, and meanwhile the connecting line L″ connecting the first contacting portion 551 and the second contacting portion 552 is through a rotating center of the rotor 57. Thus, while the rotor 57 rotates, at least one of the first and second contacting portion 551, 552 contacts with the segment. However, when the two contacting portions cross the gap, severe impact between the two contacting portions and edges of the gap is produced.

So, it is necessary to provide a new motor for solving the problems mentioned above.

### BRIEF SUMMARY OF THE INVENTION

In a preferred embodiment of the present invention, a vibrating motor comprises a base having a bearing mounting section, a magnet mounted on the base, a shaft assembled with the bearing mounting section, a pair of brushes located on the base, a rotor rotably supported by the shaft and including a body, a plurality of coils embedded in the body, and a commutator facing the brushes. Each of the brushes has a first contacting portion and a second contacting portion. The commutator defines a plurality of segments electrically connecting with the brushes, and a gap is defined between two adjacent segments. The gap extends along a radial direction of the commutator, and a connecting line connecting the first and second contacting portions is not through the shaft.

Other features and advantages of the present invention will become more apparent to those skilled in the art upon examination of the following drawings and detailed description of the preferred embodiment.

### BRIEF DESCRIPTION OF THE DRAWINGS

FIG. 1 depicts an exploded, isometric view of a flat vibrating motor related to the present invention;

FIG. 2 depicts an exploded view of the motor of FIG. 1, from another aspect;

FIG. 3 illustrates a pair of brushes engaging with a commutator of the flat motor in FIG. 1;

FIG. 4 is similar to FIG. 3, showing the commutator rotated clockwise;

FIG. 5 illustrates a pair of brushes engaging with a commutator of another flat vibrating motor related to the present invention;

FIG. 6 depicts an exploded isometric view of a flat motor in accordance with one embodiment of the present invention; and

FIG. 7 illustrates a pair of brushes engaging with a commutator of the embodiment of the present invention.

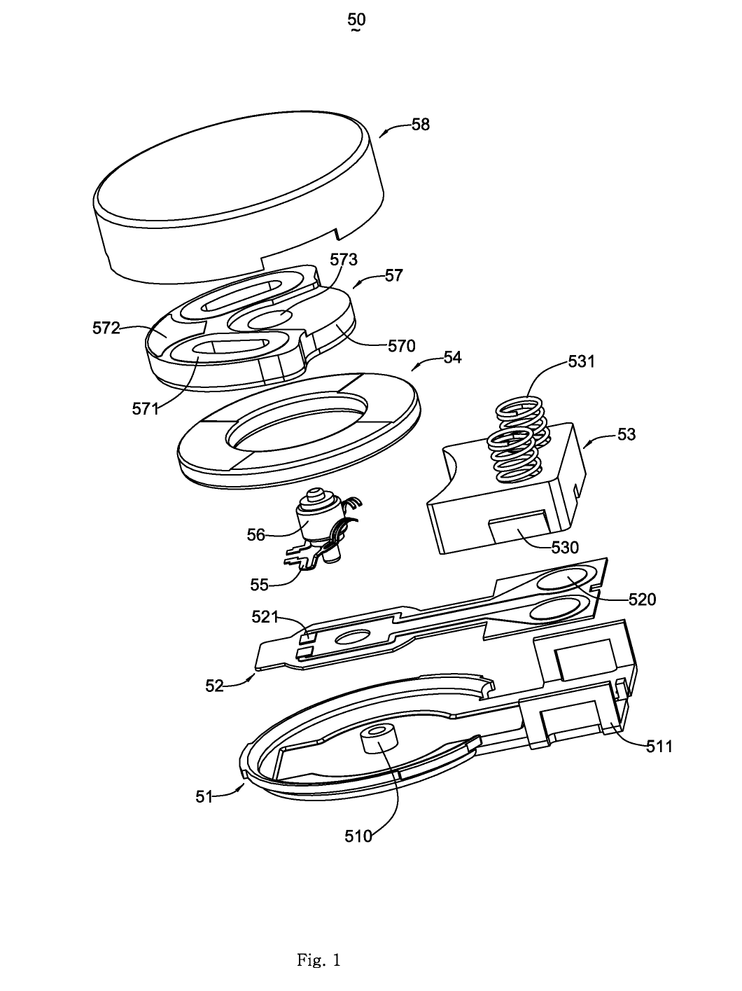

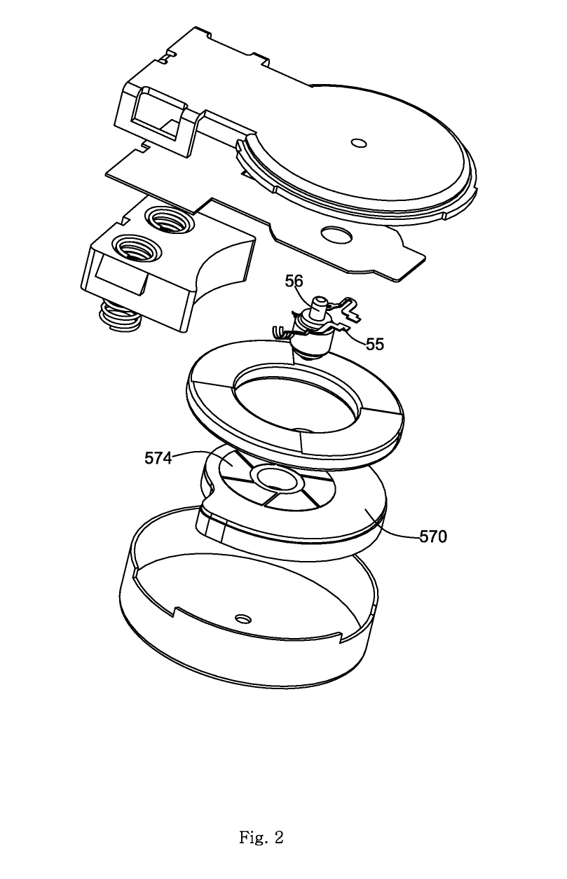

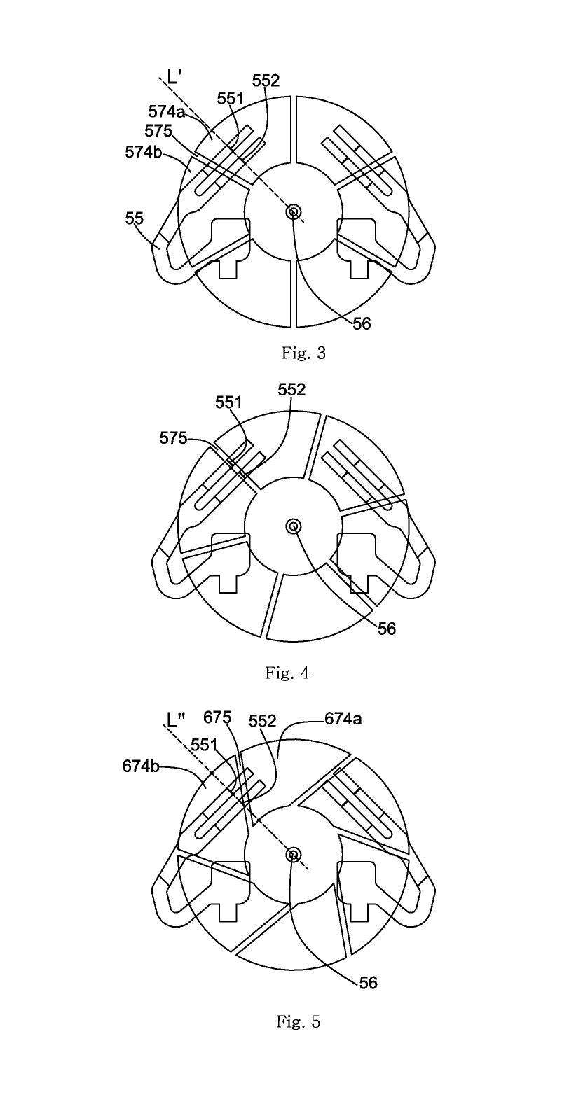

### DETAILED DESCRIPTION OF THE PREFERRED EMBODIMENT

Reference will now be made to describe one embodiment of the present invention in detail.

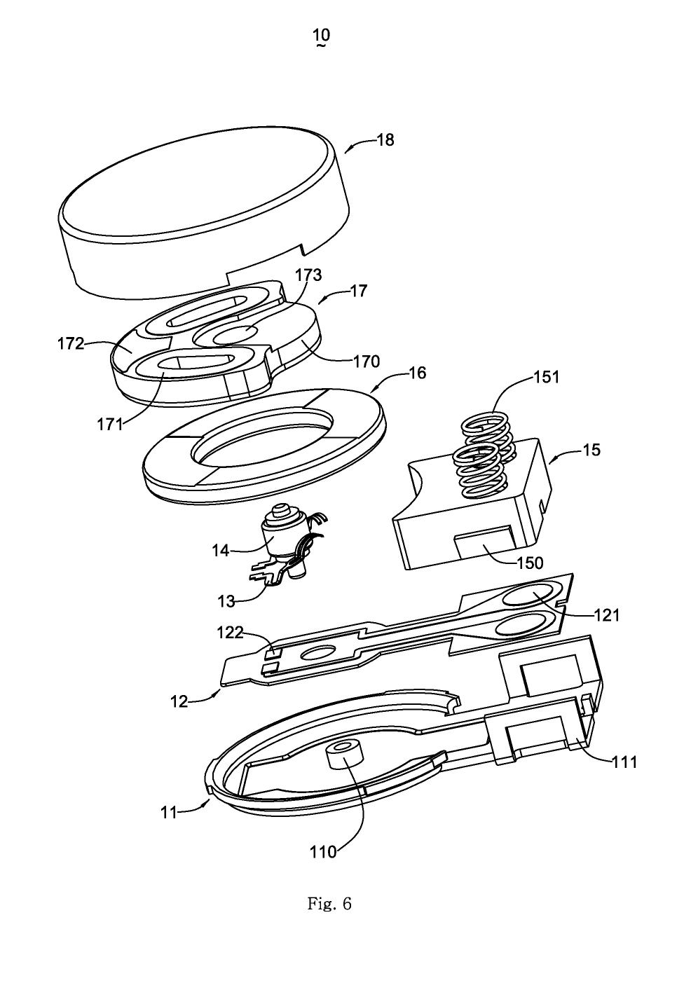

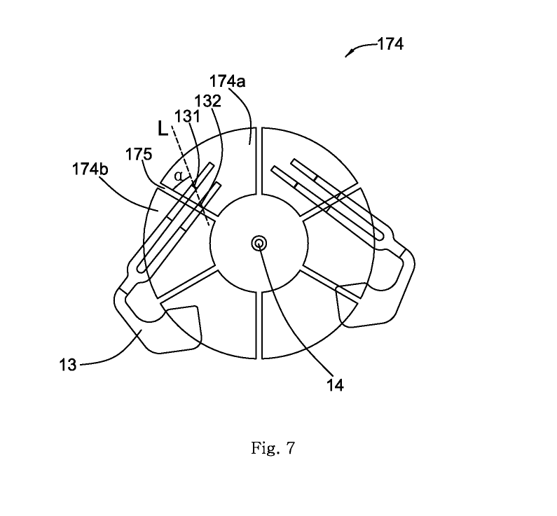

Referring to FIG. 6, an flat motor 10 in accordance with an embodiment of the present invention includes a base 11, an circuit board 12 positioned on the base 11, an electrical portion 15 electrically connecting to the circuit board 12, a magnet 16 positioned above the circuit board, a pair of brushes 13 electrically connecting to the circuit board 12, a shaft 14 rotably engaged with the base 11, a rotor 17 rotably engaged with the shaft, and an upper case 18 packaging the elements mentioned above together with the base 11.

The base 11 provides a bearing mounting section 110 assembled with the shaft 14 for rotably connecting the shaft 14 to the base, and a pair of mounting portions 111 on an end thereof.

The circuit board 12 includes a pair of first electrical terminals 121 on one end thereof and a pair of second electrical terminals 122 on another end. The electrical portion 15 defines a pair of buckles 150 coupled to the mounting portions 111 of the base 11 for fixing the electrical portion 15 with the base 11, and a plurality of electrical contacts 151 electrically connecting to the first electrical terminals 121.

The brushes 13 are coupled to the second electrical terminals 122 of the circuit board 12 by soldering.

The rotor 17 includes a body 170, a plurality of coils 171 embedded in the body 170, and a weight 172 also embedded in the body 170. The body 170 provides a hole 173. The shaft 14 is assembled with the rotor 17 by virtue of cooperation between the hole 173 and an end of the shaft 14. Further, the hole 173 is located between the two coils 171, and the weight 172 is also positioned between the two coils.

Please referring to FIG. 7, the rotor 17 further includes a commutator 174 defining a plurality of segments. The segments are electrically connected to the brushes 13 at one side and electrically connected to the coils 171 at the other side. In this embodiment, two adjacent segments are numbered 174a and 174b. When the first electrical terminals 121 receive current signals from an outer circuit via the electrical contacts 151, the current signals reach the coils 171 via the brushes 13. Activated by the electromagnetic force, the rotor 17 rotates about the shaft 14.

As shown in FIG. 7, a gap 175 is defined between two adjacent segments 174a, 174b. The gap 175 extends along a radial direction of the commutator 174. Each of the brushes 13 includes a first contacting portion 131 and a second contacting portion 132. The first and second contacting portions 131, 132 are electrically connected to the segments. A connecting line L connecting the first contacting portion 131 and the second contacting portion 132 is not through a rotating center of the rotor 17, i.e., the connecting line L is not through the shaft 14. The connecting line L deflects from the direction along which the gap extends, at any time during the rotation of the rotor. An acute angle α is formed between the connecting line and the gap 175. And at any time during the rotation of the rotor 17, the connecting line is not parallel to the gap 175. While the rotor 17 rotates, at the same time, at least one of the first and second contacting portion 131, 132 contacts with the segment.

While the present invention has been described with reference to a specific embodiment, the description of the invention is illustrative and is not to be construed as limiting the invention. Various of modifications to the present invention can be made to the preferred embodiment by those skilled in the art without departing from the true spirit and scope of the invention as defined by the appended claims.

What is claimed is:

1. A vibrating motor, comprising:
a base having a bearing mounting section;
a magnet mounted on the base;
a shaft assembled with the bearing mounting section;
a pair of brushes located on the base, each of the brushes having a first contacting portion and a second contacting portion;
a rotor rotably supported by the shaft and including a body, a plurality of coils embedded in the body, and a commutator facing the brushes, the commutator defining a plurality of segments and electrically connecting with the brushes; and
wherein a gap is defined between two adjacent segments, the gap extending along a radial direction of the commutator, and a connecting line connecting the first and second contacting portions is not through the shaft.

2. The vibrating motor as described in claim 1, wherein the base provides a mounting portion for carrying an electrical portion, and the electrical portion provides a pair of buckles coupled to the mounting portion for assembling the electrical portion with the base.

3. A vibrating motor, comprising:
a base having a bearing mounting section;
a magnet mounted on the base;
a shaft assembled with the bearing mounting section;
a pair of brushed located on the base, each of the brushes having a first contacting portion and a second contacting portion;
a rotor rotably supported by the shaft and including a body, a plurality of coils embedded in the body, and a commutator facing the brushes, the commutator defining a plurality of segment and electrically connecting with the brushes; and
wherein a gap is defined between two adjacent segments, the gap extending along a radial direction of the commutator, and a connecting line connecting the first and second contacting portions is not parallel to the gap at any time during the rotation of the rotor.

4. The vibrating motor as described in claim 3, wherein the base provides a mounting portion for carrying an electrical portion, and the electrical portion provides a pair of buckles coupled to the mounting portion for assembling the electrical portion with the base.

5. A vibrating motor, comprising:
a base having a bearing mounting section;
a magnet mounted on the base;
a shaft assembled with the bearing mounting section;
a pair of brushed located on the base, each of the brushes having a first contacting portion and a second contacting portion;
a rotor rotably supported by the shaft and including a body, a plurality of coils embedded in the body, and a commutator facing the brushes, the commutator defining a plurality of segment and electrically connecting with the brushes; and
wherein a gap is defined between two adjacent segments, the gap extending along a radial direction of the commutator, and an acute angle is formed between a connecting line connecting the first and second contacting portions and the gap, at any time during the rotation of the rotor.

6. The vibrating motor as described in claim 5, wherein the base provides a mounting portion for carrying an electrical portion, and the electrical portion provides a pair of buckles coupled to the mounting portion for assembling the electrical portion with the base.
